(19) United States
(12) Patent Application Publication
(10) Pub. No.: US 2006/0212346 A1
(43) Pub. Date: Sep. 21, 2006

(54) Systems and methods for message media content synchronization

(76) Inventors: Robert Brazell, Salt Lake City, UT (US); Robert H. Powell, Idaho Falls, ID (US)

Correspondence Address: KIRTON AND MCCONKIE, 60 EAST SOUTH TEMPLE,, SUITE 1800, SALT LAKE CITY, UT, 84111, US

(21) Appl. No.: 11/085,290

(22) Filed: Mar. 21, 2005

(51) Int. Cl. G06Q 30/00

(52) U.S. Cl. 705/14

(57) ABSTRACT

The present invention relates to systems and methods for message media content synchronization. One embodiment relates to a system that includes an advertising database, a synchronization module, and an advertising vehicle. The advertising database stores a plurality of advertisements and receives new advertisements. The synchronization module receives synchronization information and schedules advertisements from the advertising database according to the synchronization information. The synchronization information includes information related to how particular advertisements interact with one another simultaneously over various forms of media. The synchronization module then broadcasts advertisements from the advertising database according to the schedule via the advertising vehicle. Each of the processes may be performed manually or automatically depending on available resources.

### BACKGROUND

1. Field of the Invention

The present invention relates to systems and methods for message media content synchronization. More particularly, the present invention relates to synchronizing messages on different forms of media.

2. Background of the Invention and Related Art

Advertising is the process through which companies attempt to convince customers to purchase their products. Advertising takes many forms including radio, in-store audio, television, billboards, etc. Each form of media can be used to create unique advertisements. Certain types of media are preferred for certain product advertisements. Each form of media has unique properties relating to the number of potential customers reached and the frequency which these customers receive the advertisement. For example, the radio may be the preferred advertising media for pawn shops because of its ability to reach certain market segments at least once a day. Whereas, television may be the preferred media for the jewelry industry because of its ability to reach other market segments. Multiple forms of media also exist in store environments for advertising to present customers.

Occasionally these various advertising media are received simultaneously by customers. However, no current message media systems recognize the potential positive and/or negative interaction effects of broadcasting particular advertisements over different forms of media. Therefore, there is a need in the industry for a system of message media synchronization.

### SUMMARY OF THE INVENTION

The present invention relates to systems and methods for message media content synchronization. One embodiment relates to a system that includes an advertising database, a synchronization module, and an advertising vehicle. The advertising database stores a plurality of advertisements and receives new advertisements. The synchronization module receives synchronization information and schedules advertisements from the advertising database according to the synchronization information. The synchronization information includes information related to how particular advertisements interact with one another simultaneously over various forms of media. The synchronization module then broadcasts advertisements from the advertising database according to the schedule via the advertising vehicle. Each of the processes may be performed manually or automatically depending on available resources.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a representative system that provides a suitable operating environment for use of the present invention;

FIG. 2 illustrates an operational diagram of a system for message media content synchronization in accordance with one embodiment of the present invention; and

FIG. 3 illustrates a flow chart of a method for message media content synchronization in accordance with one embodiment of the present invention.

### DETAILED DESCRIPTION OF THE PREFERRED EMBODIMENTS

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

The present invention relates to systems and methods for message media content synchronization. One embodiment relates to a system that includes an advertising database, a synchronization module, and an advertising vehicle. The advertising database stores a plurality of advertisements and receives new advertisements. The synchronization module receives synchronization information and schedules advertisements from the advertising database according to the synchronization information. The synchronization information includes information related to how particular advertisements interact with one another simultaneously over various forms of media. The synchronization module then broadcasts advertisements from the advertising database according to the schedule via the advertising vehicle. Each of the processes may be performed manually or automatically depending on available resources. While embodiments of the present invention are directed at systems and methods for message media content synchronization, it will be appreciated that the teachings of the present invention are applicable to other areas.

As used in this specification, the following terms are defined accordingly:

“advertisement” and “message”—are any broadcasted messages that have the ability to directly or indirectly affect a customers purchasing choices. Therefore, general informational messages that induce customer loyalty are considered advertisements. Likewise, a traditional direct marketing message is also considered an advertisement.

“profile”—a set of characteristic information about an advertisements that includes content, target audience, media, etc.

“schedule”—a timetable of when, where, and what media to broadcast a set of advertisements. A schedule may include broadcasting individual advertisements on multiple and single forms of media. A schedule may also include broadcasting different advertisements simultaneously on different media.

“in-store media”—the various media within a store through which an in-store advertisement can be broadcast.

“proposed schedule information”—information related to when an advertisement is proposed to be broadcast including time, media, location, etc.

“profile interaction information”—information related to the interactions of various advertisement profiles. These interactions could result from simultaneous or delayed broadcast of specified advertisements with particular profiles. For example, if a Coke advertisement is broadcast at 5 pm and then a Pepsi advertisement at 5:30 pm, the profile interaction information may include the affects of this combination. In addition, the profile interaction information includes various types of interactions that result from the interactions including confusion, positive selling, store loyalty, negative selling, customer evacuation, etc.

The following disclosure of the present invention is grouped into two subheadings, namely “Exemplary Operating Environment” and “Message Content Synchronization.” The utilization of the subheadings is for convenience of the reader only and is not to be construed as limiting in any sense.

### Exemplary Operating Environment

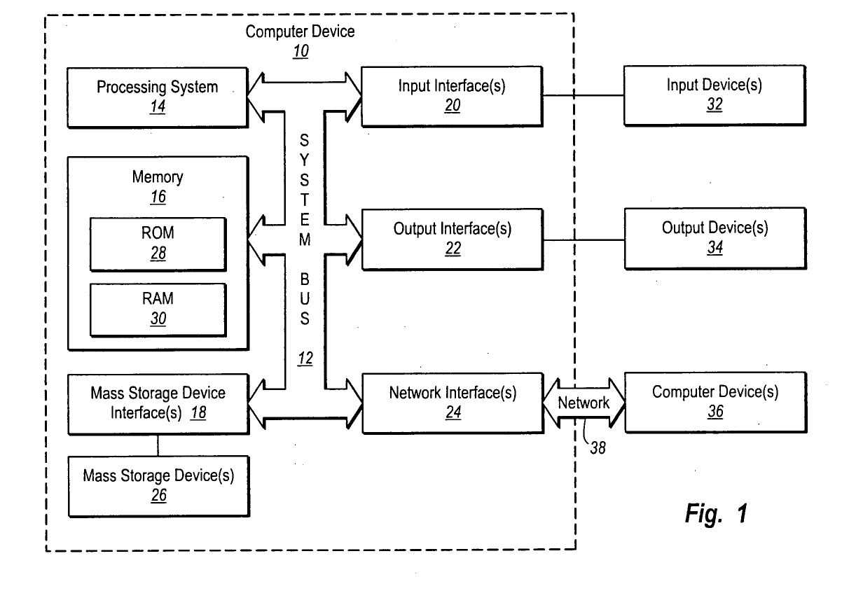

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. Alternatively, the invention may also be practiced in whole or in part manually following the same procedures. Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below. Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

### Message Content Synchronization

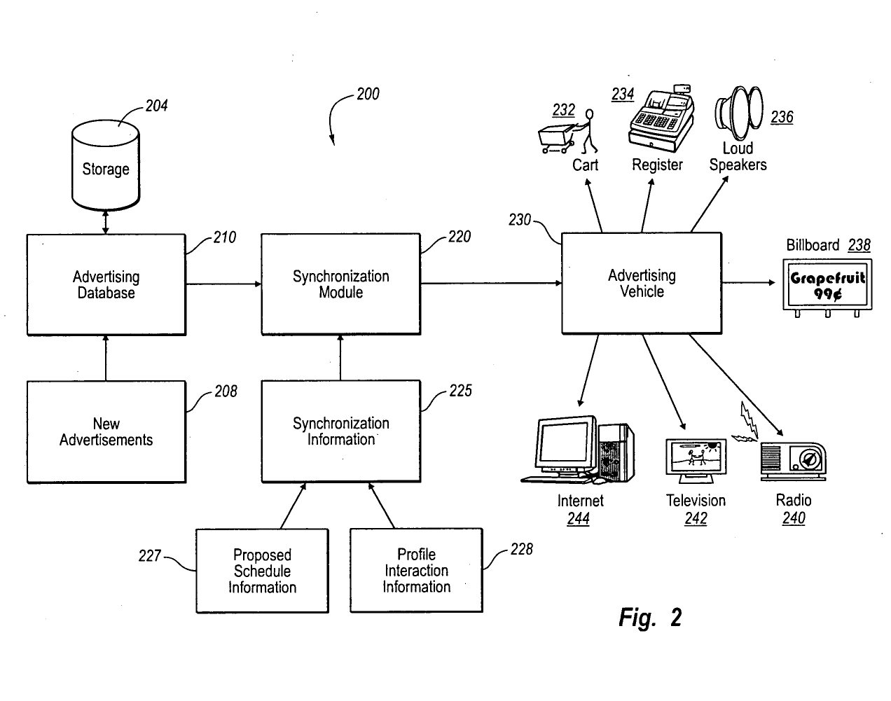

Reference is next made to FIG. 2, which illustrates an operational diagram of a system for message content synchronization in accordance with one embodiment of the present invention. The system is designated generally at 200. The system 200 includes an advertising database 210, a synchronization module 220, and an advertising vehicle 230. These modules may be co-located one the same computing device or coupled via some form of data communications. Such data communications include the Internet, wired, and wireless communication systems. In addition, one or more of these modules may incorporate manual analysis and/or functions of an individual operator.

The advertising database 210 is coupled to a storage device 204 that is configured to store numerous advertisements. The advertising database 210 also includes a profile for each of the stored advertisements. The profile relates to various individual characteristics of each advertisement. These characteristics include the content of the advertisement, the one or more media for the advertisement, the target audience of the advertisement, and optimal broadcasting times for the advertisement. The content includes any product, company, or services discussed in the advertisement. The content may also include secondary content information such as languages, video location, volume, etc. The advertising database 210 further includes receiving new advertisements 208. The new advertisements 208 may initially include a profile or a profile may be generated for them. Each of the new advertisements 208 will also be stored on the storage device 204.

The synchronization module 220 is configured to schedule advertisements from the advertising database 210 in accordance with a set of synchronization information 225. Various algorithms may be used in comparing the synchronization information 225 with the profiles in the advertising database 210 in order to generate a schedule of advertisements that is consistent with the synchronization information 225. These algorithms may weigh and prioritize interactions, particular products, certain targeted customers, etc.

The synchronization information 225 used in generating the schedule further includes proposed schedule information 227 and profile interaction information 22 8. The proposed schedule information 227 relates to desired media, location, and time at which one or more advertisements may be played. For example, the proposed schedule information 227 may indicate that a particular diaper advertisement should be scheduled in the middle of the day, over an in-store radio, and located in suburban stores. The profile interaction information 228 relates to various interactions that may occur between advertisements that contain certain profiles. These interactions could result from simultaneous or delayed broadcast of specified advertisement profiles. For example, if a Coke advertisement is broadcast at 5 pm and then a Pepsi advertisement at 5:30 pm, the profile interaction information may include the affects of this combination. In addition, the profile interaction information 228 includes various types of customer reactions that result from the interactions including confusion, positive selling, store loyalty, negative selling, customer evacuation, etc. All of this information is analyzed by the synchronization module 220 in generating the schedule. Various alternative embodiments in which the synchronization module 220 only utilizes a portion of this information to generate the schedule of advertisements, is consistent with the teachings of this invention.

The advertising vehicle 230 is configured to broadcast the schedule of advertisements generated by the synchronization module 220. The advertising vehicle is coupled to a plurality of media or advertising mediums including a cart 232, a register 234, a loudspeaker 236, a billboard 238, a radio 240, a television 242, and the internet 244. Individual advertisements may be broadcast on any one or more media depending on the schedule. Likewise, multiple advertisements may be broadcast simultaneously over different media if specified in the schedule. The media may include in-store advertising media and/or out of store general population media. Various communication systems and network configurations may be used to broadcast the advertisements including the Internet, wired connections (Global networks, local networks, point to point, Ethernet, firewire, etc), and wireless connections (802.11, Bluetooth, UWB, ad-hoc, etc). For example, if the schedule indicates that a banana advertisement is to be broadcast on all carts at 2 pm, the advertising vehicle 230 may utilize a wireless data connection to transmit the advertisement to all carts within range such that a mounted cart display screen properly displays and/or plays the advertisements. Any type of advertising media that is capable of directly or indirectly changing the purchase decisions of a customer may be incorporated and utilized with this invention.

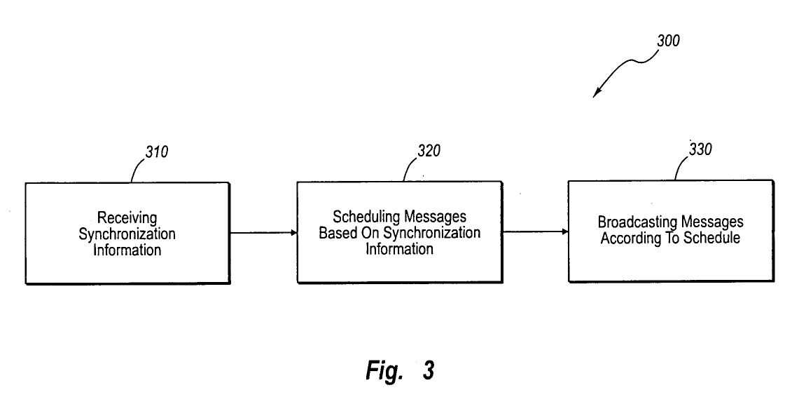

Reference is next made to FIG. 3, which illustrates a flow chart of a method for message content synchronization in accordance with one embodiment of the present invention. The method is designated generally at 300. This method may be utilized in conjunction with the system described above or may be utilized independently. Initially a set of synchronization information is received, act 310. This act further includes receiving a plurality of messages, proposed scheduling information, and profile interaction information. The plurality of messages includes individual profiles which contain information about the characteristics of the corresponding messages. The proposed schedule information relates to desired media, location, and time at which one or more messages may be played. For example, the proposed schedule information may indicate that a particular diaper message should be scheduled in the middle of the day, over an in-store radio, and located in suburban stores. The profile interaction information relates to various interactions that may occur between messages that contain certain profiles. These interactions could result from simultaneous or delayed broadcast of specified messages profiles. For example, if a Coke message is broadcast at 5 pm and then a Pepsi message at 5:30 pm, the profile interaction information may include the affects of this combination. In addition, the profile interaction information includes various types of interactions that result from the interactions including confusion, positive selling, store loyalty, negative selling, customer evacuation, etc.

A schedule of messages is generated utilizing the synchronization information, act 320. The generating of the schedule incorporates using a particular algorithm to analyze all of the synchronization information and generate a consistent schedule. Various algorithms that give priorities, weights, incorporate pricing schemes, or that rank message content, may be used in the completion of this act. The schedule includes broadcasting time, location, and media for a plurality of messages. The schedule may be confined to a single retail store, open 12 hours a day, with only three forms of message media, or it may incorporate large numbers of locations, times, and message media.

The messages are then broadcast according to the schedule, act 320. The broadcasting may include broadcasting a single message on multiple media simultaneously or at different times. Likewise, multiple messages may be broadcast simultaneously over different media if specified in the schedule. The media may include in-store message media and/or out of store general population media. Various communication systems and network configurations may be used to broadcast the messages including the Internet, wired connections (Global networks, local networks, point to point, Ethernet, firewire, etc), and wireless connections (802.11, Bluetooth, UWB, ad-hoc, etc). For example, if the schedule indicates that a banana message is to be broadcast on all carts at 2 pm, the act may include utilizing a wireless data connection to transmit the message to all carts within range such that a mounted cart display screen properly displays and/or plays the messages. Any type of message media that is capable of directly or indirectly changing the purchase decisions of a customer may be incorporated and utilized with this invention.

Thus, as discussed herein, the embodiments of the present invention relate to systems and methods for message media content synchronization. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed and desired to be secured by Letters Patent is:

1. A system for message media content synchronization comprising:
an advertising database configured to store a plurality of advertisements;
a synchronization module configured to create a schedule of advertisements from the advertising database according to a set of synchronization information; and
an advertising vehicle that is configured to broadcast the schedule of advertisements via at least two advertising media.

2. The system of claim 1, wherein the advertising database further includes a storage device capable of storing the plurality of advertisements.

3. The system of claim 1, wherein the advertising database is configured to store a plurality of different media advertisements.

4. The system of claim 1, wherein the advertising database includes profiles on each of the stored plurality of advertisements, wherein the profiles relate to various characteristics of the advertisements.

5. The system of claim 4, wherein the synchronization information includes profile interaction information which is analyzed in relation to the profiles stored in the advertising database and then utilized by the synchronization module in creating a schedule of advertisements.

6. The system of claim 5, wherein the profile interaction information includes conflicts, positive interactions, negative interactions, and confusing interactions.

7. The system of claim 1, wherein the synchronization information includes proposed scheduling information which is utilized by the synchronization module in creating a schedule of advertisements.

8. The system of claim 1, wherein the advertising vehicle includes a data communication system including at least one of a wired connection and a wireless connection.

9. The system of claim 1, wherein the advertising database, synchronization module, and advertising vehicle are disposed on at least two independent computing systems data coupled via a data link.

10. The system of claim 9, wherein the data link includes at least one of the Internet, a wired connection, and a wireless connection.

11. A system for message media content synchronization comprising:
an advertising database configured to store a plurality of advertisements, wherein a set of profiles is stored for each of the advertisements that relates to the characteristics of the advertisement;
a synchronization module configured to create a schedule of advertisements from the advertising database according to a set of synchronization information, wherein the synchronization information includes profile interaction information and proposed schedule information; and
an advertising vehicle that is configured to broadcast the schedule of advertisements via at least two advertising media.

12. A method for message media content synchronization comprising the acts of:
receiving synchronization information related to the interaction of at least two messages;
scheduling a plurality of messages based on the synchronization information; and
broadcasting the scheduled plurality of messages.

13. The method of claim 12, wherein the act of receiving synchronization information further includes:
receiving profile interaction information that indicates various message interactions based on particular message characteristics; and
receiving proposed schedule information that indicates desired message schedules for at least two media.

14. The method of claim 13, wherein the act of scheduling a plurality of messages based on the synchronization information further includes analyzing the profile interaction information and the proposed schedule information.

15. The method of claim 12, wherein the scheduled plurality of messages include messages on multiple different media.

16. The method of claim 12, wherein the act of scheduling a plurality of messages based on the synchronization information further includes analyzing profile information about the plurality of messages.
